(19) United States
(12) Patent Application Publication
(10) Pub. No.: US 2018/0347952 A1
(43) Pub. Date: Dec. 6, 2018

(54) GAS-POWERED FINGERPRINT SENSING CONTROLLED PEPPER SPRAY GUN

(71) Applicant: Ying Tang HONG, Hong Kong (HK)

(72) Inventor: Ying Tang HONG, Hong Kong (HK)

(21) Appl. No.: 15/665,392

(22) Filed: Jul. 31, 2017

(30) Foreign Application Priority Data
Jun. 6, 2017 (CN) 201710418532.0

(51) Int. Cl. F41H 9/10; G06K 9/00

(52) U.S. Cl. CPC F41H 9/10; G06K 9/0002

(57) ABSTRACT

The present invention relates to a gas-powered fingerprint sensing controlled pepper spray gun comprises a body, a handle connected to a rear end of the body, a gas handle bottom cover connected to a bottom end of the handle, a spraying device installed inside a front end of the body, a gas cylinder assembly having a gas valve connected to the spraying device, a trigger device for controlling the gas cylinder assembly, a fingerprint switch device and a liquid storage device disposed on top of the spraying device. A gas handle disassembly switch is disposed between the gas handle bottom cover and the handle. The gas-powered fingerprint sensing controlled pepper spray gun has a reasonable structure, can achieve subduction by spraying, can prevent others to use without permission, have multiple levels of security protection switches, and is safe to use.

### FIELD OF INVENTION

The present invention relates to the field of electric defensive weapons, in particular to a gas-powered fingerprint sensing controlled pepper spray gun.

### BACKGROUND OF INVENTION

Presently, the international and internal situation is unstable, and confrontations have occurred at times. When a big confrontation happens, the police needs a deterring weapon to steady the situation. While the present day police is equipped with a full set of items, such as batons, electronic map, handcuffs, cutproof armor, guns etc., due to the lethality of guns, use of guns are strictly controlled. This protects innocent people but also brings unpredictable danger to the police themselves. Police often are attacked due to not assessing the situation properly, and sometimes their lives are threatened. In such situations, even if they have guns, but the guns cannot be used due to the lethality, rendering them ineffective. Therefore it causes difficulties during arrests.

### SUMMARY OF INVENTION

The technical problem to be solved by the present invention is: to overcome the aforementioned problem, a gas-powered fingerprint sensing controlled pepper spray gun is provided. The centrifuge has the advantages of having a simple structure, sensible design, high rotational speed, and having refrigerating, angle adjustment and shatterproof recollection features. The high speed refrigerating centrifuge can also satisfy a higher requirement of material separation, refinement and purification.

The technical solution used in the present invention to solve the technical problem is: a gas-powered fingerprint sensing controlled pepper spray gun comprises a body, a handle connected to a rear end of the body, a gas handle bottom cover connected to a bottom end of the handle, a spraying device installed inside a front end of the body, a gas cylinder assembly having a gas valve connected to the spraying device, a trigger device for controlling the gas cylinder assembly, a fingerprint switch device and a liquid storage device disposed on top of the spraying device. A gas handle disassembly switch is disposed between the gas handle bottom cover and the handle.

The trigger device comprises a trigger inner housing installed inside the body, a trigger and a first return spring. The trigger comprises a horizontal lever disposed inside the trigger inner housing, an upper lever vertically connected to a top end of the horizontal lever, and a lower lever vertically connected to a bottom end of the horizontal lever. The upper lever and the lower lever is disposed on the horizontal lever with an offset. One end of the first return spring is abut against the inner wall of the trigger inner housing, the other end is connected to the horizontal lever of the trigger. The upper lever of the trigger inserts into the body to connect to the gas switch, the gas switch is connected to the gas valve. The lower lever of the trigger penetrates out of the body in front of the handle. Opening of the gas valve is controlled through the upper lever of the trigger.

The fingerprint switch device comprises a fingerprint identifying module and a switch device. The switch device comprises a rotary valve switch disposed on the gas valve, a pull handle disposed on the rotary valve switch, a drive rod hinged to the pull handle, guide posts disposed on the wall of the body for limiting the movement of the drive rod, a second return spring disposed on the drive rod and a driving mechanism drivably connected to the guide posts.

The gas cylinder assembly is formed by a first gas cylinder and a second gas cylinder. The first gas cylinder and the second gas cylinder is accommodated inside a chamber between the gas handle bottom cover and the handle. A first gas tube is connected to the mouth of the first gas cylinder, a second gas tube is connected to the mouth of the second gas cylinder. One end of the first gas tube and the second gas tube is connected to the gas valve.

Furthermore, the spraying device comprises a spraying cylinder and a magazine vertically disposed inside a front end of the body, a one-way gas valve and a gas chamber plug. The nozzle of the spraying cylinder penetrates out of the front end of the body, another end of the spraying cylinder is connected to a third gas tube. The third gas tube is connected to the second gas tube through the gas valve. The one-way gas valve is disposed at a connection point between the spraying cylinder and the third gas tube. One end of the magazine is connected to the front end of the body, another end is connected to a fourth gas tube. The fourth gas tube is connected to the first gas tube through the gas valve. The gas chamber plug is disposed at a connection point between the magazine and the fourth gas tube.

In a preferred embodiment, the liquid storage device is disposed at an upper part of the spraying device, comprising a liquid tank, a squeeze piston disposed at a rear end of the liquid tank and a compression spring. A bottom part of the front end of the liquid tank is connected to the spraying cylinder. A liquid mouth is disposed at an upper part of the front end of the liquid tank.

In a preferred embodiment, a liquid scale is provided on the spraying cylinder, the liquid scale is from 0-10 mL.

In a preferred embodiment, gas pressure gauges protruding from the body are disposed on the first gas tube and the second gas tube.

In a preferred embodiment, the fingerprint identifying module comprises a fingerprint identifying touch panel disposed at a side of the handle and control circuitry. The fingerprint identifying touch panel and the driving mechanism is electrically connected to the control circuitry. A control chip, a fingerprint storage unit and a fingerprint comparing unit are disposed inside the control circuitry.

In a preferred embodiment, a U-shaped rail for latching to the drive rod is disposed at a center part of the guide post. A limiter block is disposed at a center part of the drive rod for abutting against the second return spring.

In a preferred embodiment, an elongated rail is disposed at a tail end of the pull handle for hinging to the drive rod.

In a preferred embodiment, the driving mechanism uses micro gear motor or electromagnet.

The advantage of the present invention is: the gas-powered fingerprint sensing controlled pepper spray gun of the present invention has a reasonable structure, controls the switching of the gas valve through the fingerprint switching device, effectively preventing other people to use. When the trigger device is activated, the gas in the gas cylinder assembly drives the liquid in the spraying device to spray, with double gas cylinder driving, can achieve subduction by spraying. Magazine has a gas chamber plug inside, when not in use for prolong period of time, removing the gas tank cork can prevent accidental triggering, therefore reducing safety concerns.

### BRIEF DESCRIPTION OF DRAWINGS

The present invention is further explained below with the accompanying drawings and embodiments.

FIG. 1 is a structural schematic diagram of the internal structure of a gas-powered fingerprint sensing controlled pepper spray gun according to the present invention.

FIG. 2 is a structural schematic diagram of the external structure of a gas-powered fingerprint sensing controlled pepper spray gun according to the present invention.

FIG. 3 is a structural schematic diagram of a fingerprint switch device of a gas-powered fingerprint sensing controlled pepper spray gun according to the present invention.

FIG. 4 is a circuit schematic diagram of a gas-powered fingerprint sensing controlled pepper spray gun according to the present invention.

Reference numbers in the drawings: 1 body, 11 guide post, 2 handle, 21 fingerprint identifying touch panel, 22 control circuitry, 23 fingerprint storage unit, 24 fingerprint comparing unit, 3 gas handle bottom cover, 4 spraying device, 41 spraying cylinder, 42 magazine, 43 one-way gas valve, 44 gas chamber plug, 45 third gas tube, 46 fourth gas tube, 47 liquid scale, 5 gas cylinder assembly, 51 first gas cylinder, 52 second gas cylinder, 53 first gas tube, 54 second gas tube, 55 gas valve, 551 rotary valve switch, 552 pull handle, 5521 elongated rail, 553 drive rod, 5531 limiter block, 554 second return spring, 555 driving mechanism, 56 pressure gauge, 6 trigger device, 61 trigger inner housing, 62 trigger, 62-1 horizontal lever, 62-2 upper lever, 62-3 lower lever, 63 first return spring, 64 gas switch, 7 gas handle disassembly switch, 9 liquid storage tank, 91 squeeze piston, 92 compression spring, 93 liquid mouth.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

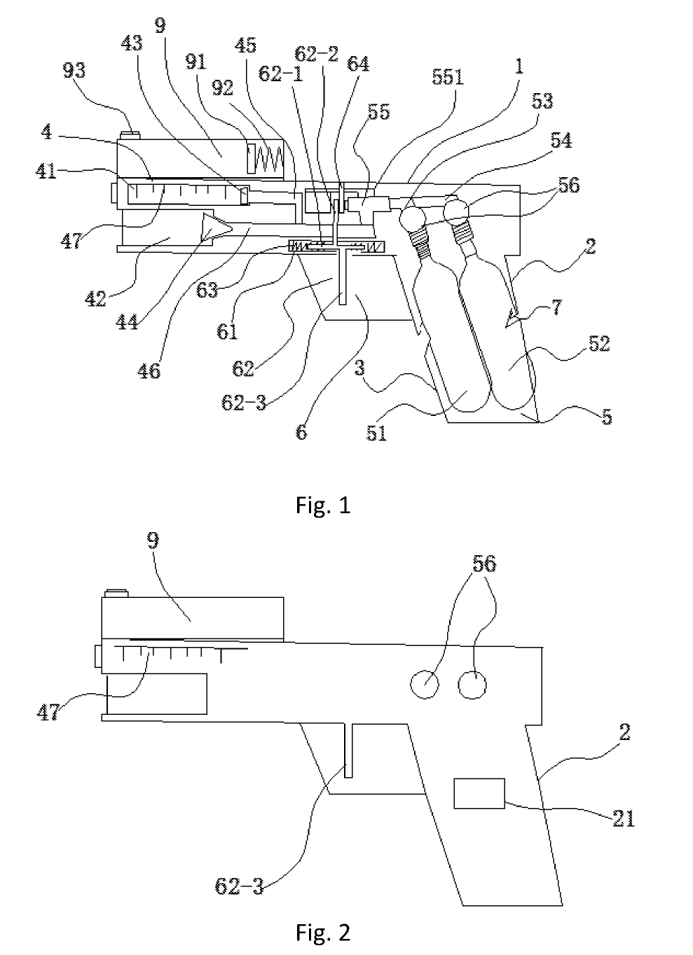

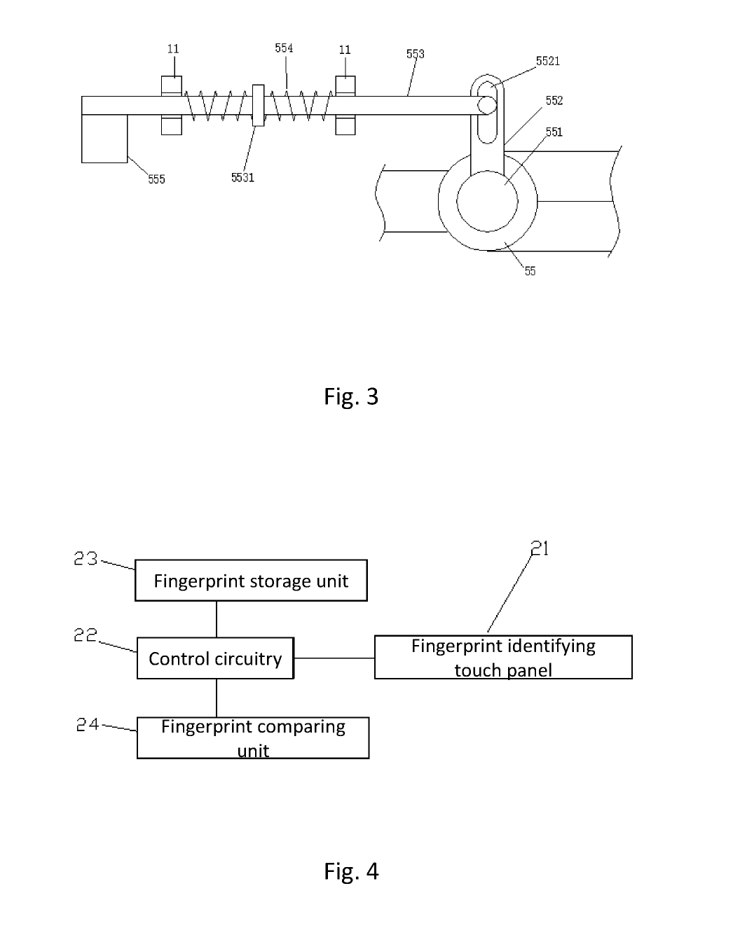

A gas-powered fingerprint sensing controlled pepper spray gun is shown in FIGS. 1, 2, 3 and 4. The pepper spray gun comprises a body 1, a handle 2 connected to a rear end of the body 1, a gas handle bottom cover 3 connected to a bottom end of the handle 2, a spraying device 4 installed inside a front end of the body 1, a gas cylinder assembly 5 having a gas valve 55 connected to the spraying device 4, a trigger device 6 for controlling the gas cylinder assembly 5, a fingerprint switch device and a liquid storage device disposed on top of the spraying device 4. A gas handle disassembly switch 7 is disposed between the gas handle bottom cover 3 and the handle 2. The trigger device 6 comprises a trigger inner housing 61 installed inside the body 1, a trigger 62 and a first return spring 63. The trigger comprises a horizontal lever 62-1 disposed inside the trigger inner housing 61, an upper lever 62-2 vertically connected to a top end of the horizontal lever 62-1, and a lower lever 62-3 vertically connected to a bottom end of the horizontal lever 62-1. The upper lever 62-2 and the lower lever 62-3 is disposed on the horizontal lever 62-1 with an offset. One end of the first return spring 63 is abut against the inner wall of the trigger inner housing 61, the other end is connected to the horizontal lever 62-1 of the trigger 62. The upper lever 62-2 of the trigger 62 inserts into the body 1 to connect to the gas switch 64, the gas switch 64 is connected to the gas valve 55. The lower lever 62-3 of the trigger 62 penetrates out of the body 1 in front of the handle 2. Opening of the gas valve 55 is controlled through the upper lever 62-2 of the trigger 62. The fingerprint switch device comprises a fingerprint identifying module and a switch device. The switch device comprises a rotary valve switch 551 disposed on the gas valve 55, a pull handle 552 disposed on the rotary valve switch 551, a drive rod 553 hinged to the pull handle 552, guide posts 11 disposed on the wall of the body 1 for limiting the movement of the drive rod 553, a second return spring 554 disposed on the drive rod 553 and a driving mechanism 555 drivably connected to the guide posts 11.

The gas cylinder assembly 5 is formed by a first gas cylinder 51 and a second gas cylinder 52. The first gas cylinder 51 and the second gas cylinder 52 is accommodated inside a chamber between the gas handle bottom cover 3 and the handle 2. A first gas tube 53 is connected to the mouth of the first gas cylinder 51, a second gas tube 54 is connected to the mouth of the second gas cylinder 52. One end of the first gas tube 53 and the second gas tube 54 is connected to the gas valve 55.

The spraying device 4 comprises a spraying cylinder 41 and a magazine 42 vertically disposed inside a front end of the body 1, a one-way gas valve 43 and a gas chamber plug 44. The nozzle of the spraying cylinder 41 penetrates out of the front end of the body 1, another end of the spraying cylinder 41 is connected to a third gas tube 45. The third gas tube 45 is connected to the second gas tube 54 through the gas valve 55. The one-way gas valve 43 is disposed at a connection point between the spraying cylinder 41 and the third gas tube 45. One end of the magazine 42 is connected to the front end of the body 1, another end is connected to a fourth gas tube 46. The fourth gas tube 46 is connected to the first gas tube 53 through the gas valve 55. The gas chamber plug 44 is disposed at a connection point between the magazine 42 and the fourth gas tube 46.

The liquid storage device is disposed at an upper part of the spraying device 4, comprising a liquid tank 9, a squeeze piston 91 disposed at a rear end of the liquid tank 9 and a compression spring 92. A bottom part of the front end of the liquid tank 9 is connected to the spraying cylinder 41. A liquid mouth 93 is disposed at an upper part of the front end of the liquid tank 9. A liquid scale 47 is provided on the spraying cylinder 41, the liquid scale 47 is from 0-10 mL. Gas pressure gauges 56 protruding from the body 1 are disposed on the first gas tube 53 and the second gas tube 54.

The fingerprint identifying module comprises a fingerprint identifying touch panel 21 disposed at a side of the handle 2 and control circuitry 22. The fingerprint identifying touch panel 21 and the driving mechanism 555 is electrically connected to the control circuitry 22. A control chip, a fingerprint storage unit 23 and a fingerprint comparing unit 24 are disposed inside the control circuitry.

A U-shaped rail for latching to the drive rod 553 is disposed at a center part of the guide post 11. A limiter block 5531 is disposed at a center part of the drive rod 553 for abutting against the second return spring 554. An elongated rail 5521 is disposed at a tail end of the pull handle 552 for hinging to the drive rod 553. The driving mechanism 555 uses micro gear motor or electromagnet.

The gas-powered fingerprint sensing controlled pepper spray gun of the present invention has a reasonable structure, controls the switching of the gas valve 55 through the fingerprint switching device, effectively preventing other people to use. When the trigger device 6 is activated, the gas in the gas cylinder assembly 5 drives the liquid in the spraying device 4 to spray, with double gas cylinder driving, can achieve subduction by spraying. Magazine 42 has a gas chamber plug 44 inside, when not in use for prolong period of time, removing the gas tank cork 44 can prevent accidental triggering, therefore reducing safety concerns.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A gas-powered fingerprint sensing controlled pepper spray gun, comprising: a pepper spray gun comprises a body, a handle connected to a rear end of the body, a gas handle bottom cover connected to a bottom end of the handle, a spraying device installed inside a front end of the body, a gas cylinder assembly having a gas valve connected to the spraying device, a trigger device for controlling the gas cylinder assembly, a fingerprint switch device and a liquid storage device disposed on top of the spraying device; a gas handle disassembly switch is disposed between the gas handle bottom cover and the handle;
the trigger device comprises a trigger inner housing installed inside the body, a trigger and a first return spring; the trigger comprises a horizontal lever disposed inside the trigger inner housing, an upper lever vertically connected to a top end of the horizontal lever, and a lower lever vertically connected to a bottom end of the horizontal lever; the upper lever and the lower lever is disposed on the horizontal lever with an offset; one end of the first return spring is abut against the inner wall of the trigger inner housing, the other end is connected to the horizontal lever of the trigger; the upper lever of the trigger inserts into the body to connect to the gas switch, the gas switch is connected to the gas valve; the lower lever of the trigger penetrates out of the body in front of the handle; opening of the gas valve is controlled through the upper lever of the trigger;
the fingerprint switch device comprises a fingerprint identifying module and a switch device;
the switch device comprises a rotary valve switch disposed on the gas valve, a pull handle disposed on the rotary valve switch, a drive rod hinged to the pull handle, guide posts disposed on the wall of the body for limiting the movement of the drive rod, a second return spring disposed on the drive rod and a driving mechanism drivably connected to the guide posts.

2. The gas-powered fingerprint sensing controlled pepper spray gun according to claim 1, characterized in that: the gas cylinder assembly is formed by a first gas cylinder and a second gas cylinder; the first gas cylinder and the second gas cylinder is accommodated inside a chamber between the gas handle bottom cover and the handle; a first gas tube is connected to the mouth of the first gas cylinder, a second gas tube is connected to the mouth of the second gas cylinder; one end of the first gas tube and the second gas tube is connected to the gas valve.

3. The gas-powered fingerprint sensing controlled pepper spray gun according to claim 1, characterized in that: the spraying device comprises a spraying cylinder and a magazine vertically disposed inside a front end of the body, a one-way gas valve and a gas chamber plug; the nozzle of the spraying cylinder penetrates out of the front end of the body, another end of the spraying cylinder is connected to a third gas tube; the third gas tube is connected to the second gas tube through the gas valve; the one-way gas valve is disposed at a connection point between the spraying cylinder and the third gas tube; one end of the magazine is connected to the front end of the body, another end is connected to a fourth gas tube; the fourth gas tube is connected to the first gas tube through the gas valve; the gas chamber plug is disposed at a connection point between the magazine and the fourth gas tube.

4. The gas-powered fingerprint sensing controlled pepper spray gun according to claim 1, characterized in that: the liquid storage device is disposed at an upper part of the spraying device, comprising a liquid tank, a squeeze piston disposed at a rear end of the liquid tank and a compression spring; a bottom part of the front end of the liquid tank is connected to the spraying cylinder; a liquid mouth is disposed at an upper part of the front end of the liquid tank.

5. The gas-powered fingerprint sensing controlled pepper spray gun according to claim 1, characterized in that: a liquid scale is provided on the spraying cylinder, the liquid scale is from 0-10 mL.

6. The gas-powered fingerprint sensing controlled pepper spray gun according to claim 1, characterized in that: gas pressure gauges protruding from the body are disposed on the first gas tube and the second gas tube.

7. The gas-powered fingerprint sensing controlled pepper spray gun according to claim 1, characterized in that: the fingerprint identifying module comprises a fingerprint identifying touch panel disposed at a side of the handle and control circuitry; the fingerprint identifying touch panel and the driving mechanism is electrically connected to the control circuitry; a control chip, a fingerprint storage unit and a fingerprint comparing unit are disposed inside the control circuitry.

8. The gas-powered fingerprint sensing controlled pepper spray gun according to claim 1, characterized in that: a U-shaped rail for latching to the drive rod is disposed at a center part of the guide post; a limiter block is disposed at a center part of the drive rod for abutting against the second return spring.

9. The gas-powered fingerprint sensing controlled pepper spray gun according to claim 1, characterized in that: an elongated rail is disposed at a tail end of the pull handle for hinging to the drive rod.

10. The gas-powered fingerprint sensing controlled pepper spray gun according to claim 1, characterized in that: the driving mechanism uses micro gear motor or electromagnet.
